(19) United States
(12) Patent Application Publication
(10) Pub. No.: US 2011/0158172 A1
(43) Pub. Date: Jun. 30, 2011

(54) METHOD AND DEVICE FOR ENFORCING INTERNET USERS' GEOGRAPHICAL POSITIONING TRACEABILITY

(75) Inventors: Mohamed Mancona Kande, Preverenges (CH); Arnaud Burlet, Pully (CH)

(73) Assignee: E-MMUNIZER SA

(21) Appl. No.: 13/001,990

(22) PCT Filed: Jun. 30, 2008
(86) PCT No.: PCT/EP08/58404

§ 371 Date: Mar. 2, 2011

(51) Int. Cl. H04W 4/02

(52) U.S. Cl. 370/328

(57) ABSTRACT

A method for enforcing Internet users' geographical positioning traceability, through the building of a community of several network elements with known geographical locations with identified boundaries. The network access to the community is controlled and access of external devices to the community is only possible within one connectivity hop from the network elements of the community.

The present invention deals with a system and method for reliably tracing and localizing Internet users.

### DESCRIPTION OF RELATED ART

It is well known that network operators such as Internet service providers (ISPs) keep track of users' profiles and record their relative network usage (e.g. on a time basis or based on the volume of data exchanged), notably for network dimensioning and for billing purposes. Different identification and authentication mechanisms allow to grant the access to the network only when a set of conditions are fulfilled, such as a preliminary registration giving personal information and e.g. a physical home address. In this case, the users are supposed to access the network at their home's place.

For mobile network operators, registered users' credentials can be stored e.g. on a SIM card to authenticate users, which can be localized by the nearest base station they are connected to. The size of the cells, even in the case of 3G networks like UMTS whose radii are radically shorter than the 2G networks such as GSM, does not yet allow to determine the geographical position of a user with an acceptable precision for emergency services or any kind of tracking purposes required by authorities.

The increasing integration of global navigation satellite systems, (GNSS) such as the GPS technology, into mobile or portable devices makes it now possible to track the geographical positioning of people with a better accuracy; the coupling between the GPS and mobile radio technologies have paved the way for so-called location-based services. US20020046104 describes a target-based advertising method using such a coupling. It has to be noted however, that the tracking of mobile users is only possible with such dual (e.g. GPS/GSM) devices, which makes up a strong technological requirement preventing network operators from offering a universal solution for a reliable real-time localization of users. This universal feature can however be demanded by local authorities for public security purposes.

Despite intensive deployment of full mobile Internet networks complying with the 3GPP standard in the recent years, experience has yet shown that many Internet users only require a sporadic access to Internet but no always-on connectivity. A new batch of LAN (local area networks) technologies such as Wi-Fi technologies, a.k.a. WLAN, have emerged to offer such nomadic wireless services in so-called “Hot-Spots” such as railway stations, cafes, airports etc., where the demand for Internet connectivity is relatively high. As a result, so-called WISPs (wireless Internet service providers) have come to the fore to satisfy those occasional connectivity needs. For commodity reasons and ease of use, the WLAN is also increasingly used at home, where combined WLAN/DSL routers are extremely popular.

WISPs themselves as well as their network component suppliers became rapidly aware that location-based information are useful for third parties' service providers and deployed geographic-based communications service systems establishing a logical link between the network address used by an Internet access user, and its physical location. WO2006031379 describes for example a solution for determining access points (APs) to which users are connected through part of its IP network address such as a subnet mask, so that they can be addressed by target-based advertising. US2001043148 describes a similar target-based advertising system in which users are recognized by the access point they are connected to, and whose physical location is known, so that relevant information related to the geographical location of the involved access points can be sent to the connected users.

The use of matching tables and databases for identifying access points and localizing their connected terminals e.g. thanks to their MAC address, is also known. A network planning scheme using IPv6 providing embedded geographical information through specific suffix assignments is described in US20050018645.

No disclosed system and method can however address the issue of non-regulated Internet intermediaries, i.e. network access components that are not managed by trustworthy companies but e.g. by individuals or organizations, etc., which are ready to share their access bandwidth. Those non-regulated Internet intermediaries, and more generally all the network access components beyond the ones managed by ISPs, are not subject to any regulation constraints, like for example providing traffic and user information whenever necessary to local authorities. In order to fight cybercrime though, malicious Internet users need to be identified and localized rapidly and with the best possible accuracy, for e.g. the police to intervene efficiently.

A shortcoming of the current systems is that traceability to the users, through e.g. their IP address, is usually only possible until a NAT (network address translation) is performed, usually at the ISP level. With the rapidly growing number of so-called “free Wi-Fi spots”, “Hot-zones” offered either as a free public service by individuals, or simply as a free service by companies (e.g. some fast-food restaurants) it is hence not possible to trace the users until their nearest access point, but only until the ISP boundaries, i.e. network components that are still regulated. The case of wild meshed networks, e.g. in student communities, appears therefore especially dangerous due to the inability to manage the exposition to a growing number of Internet risks. The same applies to so-called “Ad-Hoc” networks allowing for peer-to-peer connectivity without any centralized or distributed control.

### BRIEF SUMMARY OF THE INVENTION

It is therefore an aim of the invention to provide a traceability and positioning system and method for Internet users free of the drawbacks known in the art.

It is another aim of the invention to allow an enhanced geographical localization system which does not require cumbersome GPS integration into mobile devices for real-time positioning.

According to the invention, these aims are achieved by means of the method and system of the independent claims, while preferred embodiments are described with the help of the dependent claims.

Advantages of the disclosed invention include:
providing a universal solution usable with minimal device capabilities requirements;
providing an easy operable solution, compliant with possibly any desirable identification and authentication process and technology;
enabling Internet risk management, excluding non traceable users;
complying with the strong geographical traceability requirements desired by local authorities (e.g. police);
preventing non traceable people from accessing the Internet through a third party connection, or even any connection where no identification is required (e.g. free public Wi-Fi networks).

### BRIEF DESCRIPTION OF THE DRAWINGS

The invention will be better understood with the aid of the description of an embodiment given by way of example and illustrated by the figures, in which:

FIG. 1 shows a system with a traceable community according to a preferred embodiment of the invention;

FIG. 2 shows a flow chart describing the traceable community set-up and building process;

FIG. 3 shows a system with an embedded LIRS (local Internet regulation system);

FIG. 4 shows a flow chart describing an embodiment of the identification and authentication of an end-user through an end-device.

### DETAILED DESCRIPTION OF POSSIBLE EMBODIMENTS OF THE INVENTION

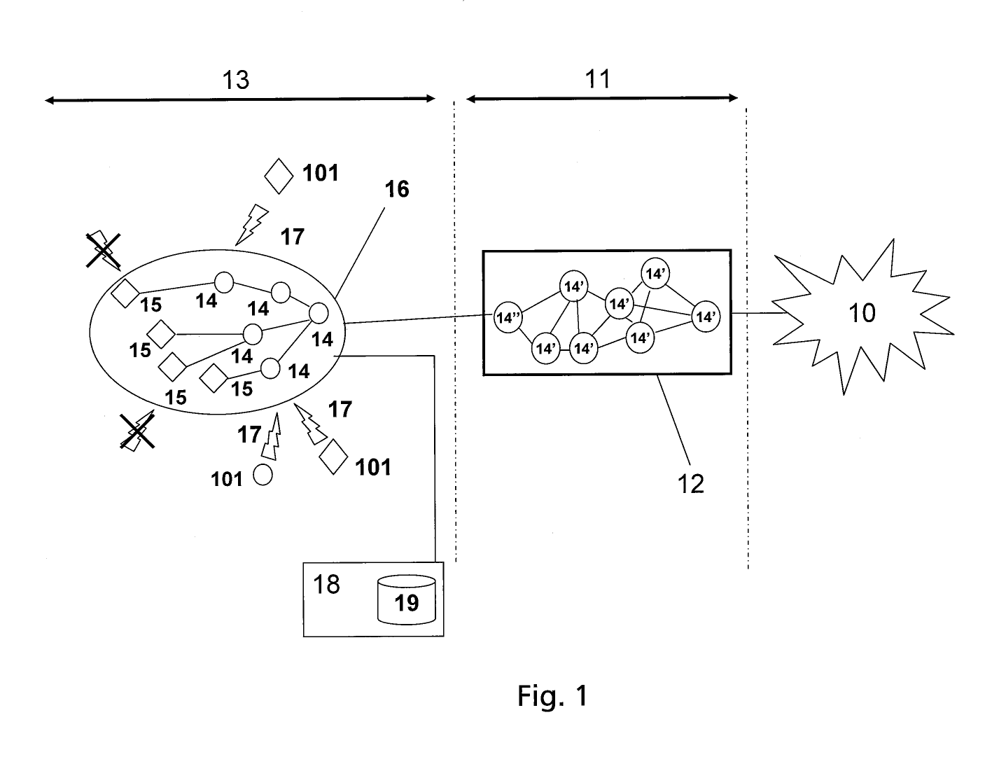

FIG. 1 describes a typical network topology for accessing the Internet 10 (for example the web), highlighting the gist of the invention.

Access to the Internet is usually provided through an ISP, whose network 12 comprises various so-called network elements 14′ which can transport and route IP packets to a given destination. Those network elements 14′, comprising typically switches, routers and servers, are addressable and manageable by the ISP network operator, and a hierarchical addressing plan is usually set up, taking into account their physical location, like a postal network assigning postal codes. The network elements 14′ of the ISP network 12 are usually assigned an available public IP address. At the border of the ISP network, a border network element 14″, for example a DSL router, a cable modem, or any type of broadband gateway in the case of a private Internet access at home, is the last network element managed by the ISP network operator. Across the boundary illustrated (in dotted line at the left of the ISP network 12), there can be a plurality of other network elements 14, such as access points (AP), computers or laptops which are not managed by the operator. Typically, private IP addresses on a home network or any private subnetwork can be dynamically assigned behind a NAT (network address translation), e.g. at the DSL router level, as opposed to the public IP addresses used by the ISP and preventing the traceability and localization of such network elements.

As a result, one can distinguish so-called regulated Internet intermediaries 11, located between the dashed lines separating any ISP network with the Internet on the one hand, and any private network on the other, as opposed to non regulated Internet intermediaries 13 making up private networks, possibly with private IP addresses and non managed network elements 14. According to the disclosed network topology and logical segmentation, these network elements 14 are not only not managed by the ISP, but not even manageable by any ISP.

Let's now take a simple example of the growing lack of safety arising with Internet with the advent of Wi-Fi technologies. An increasing number of persons installing a Wi-Fi access point at home often without sufficient security knowledge run major risks of persons eavesdropping their home network and also taking advantage of their bandwidth connection for freely surfing over the Internet, as long as no credentials or encryption keys are required to connect to such a personal Wi-Fi network. Moreover, in case of malicious Internet users perpetrating cybercrimes over the Internet, the traceability derived from the ISP routing information could not lead the legal authorities to the right person, but only to the person whose network has been used for accessing the Internet. Although many ISP have taken measures to warn Internet users about those risks and give them instructions on how to make their over-the-air network more secure, it cannot be taken for granted that everybody has the required skills to set up his or her home Wi-Fi network on his own with an adequate security level, ensuring that no person could illicitly use his network for perpetrating cybercrimes. There is hence a need for an end-to-end tracing and localizing mechanism, running independently from the security measures taken by the ISPs, and ensuring that persons connected can be traced and localized rapidly. In other words, it is necessary to trace the so-called non regulated Interned Intermediaries 13 which cannot be managed by ISPs. The same security requirements obviously apply to the emerging Hot-Zones or public Wi-Fi networks, where security requirements can prove to be quite low, as well as to student communities, so as to allow traceability on the users using e.g. meshed networks.

Therefore, end-to-end security requires a universal mechanism providing traceability wherever usual authentication and identification mechanisms used by ISP are not used, either on purpose, or because of a dysfunction. The proposed solution according to the invention builds a community 16 of network elements 14 ensuring end-to-end traceability and a precise localization, in order to manage precisely what could not be managed hitherto by the ISPs and provide therefore a substitute reliable traceability mechanism.

As can be seen on FIG. 1, the community 16 forms a closed group of network elements 14 which have been identified and authenticated, as explained later in this document, and organized so as to build up a tree structure. The leaves of this tree 15 are identified as the network elements which do not allow any further growth of the tree behind them, and through which no access to the community can ever be granted. The leaves of this tree are therefore not referred to as network elements anymore 14, but as end-devices 15, in the sense that they are located at the end of a tree branch and close this branch for any connection. They can therefore also be seen as boundaries of said community. This is particularly useful for preventing any unstructured growth of a network using a shared LAN (local area network) technology such as Wi-Fi meshed networks where Wi-Fi connectivity can be relayed and extended through mesh-enabled access points, or even for preventing the establishment of any PAN network (personal area network) such as Bluetooth or Ultra Wide Band (UWB) for relaying the Internet connectivity.

According to one aspect of invention, it is only possible to access the community 16 through a direct connection to the nearest network element 14, but never through a connectivity relay which would involve two connectivity hops from an external device to a network element 14, or through an end-device 15. “Hops” are a well-known metric in the routing domain standing for a link between a network element 14 and its neighbor, typically two routers. According to a preferred embodiment of the invention, a connectivity hop 17 typically consists here of any type of wireless link with any desired wireless technology (UMTS, Wi-Fi, WiMAX, UWB etc.) and preferably any connection link, either wired of wireless, whose reach is small enough to locate a neighbor of a network element 14 within preferably around 10 meters. In FIG. 1, the hops 17 are represented only between network elements 14 of the community, and external devices 101, not between network elements 14 and end-device 15 belonging to the community. It will be appreciated that there is also one hop between each network elements 14 and/or end-devices 15.

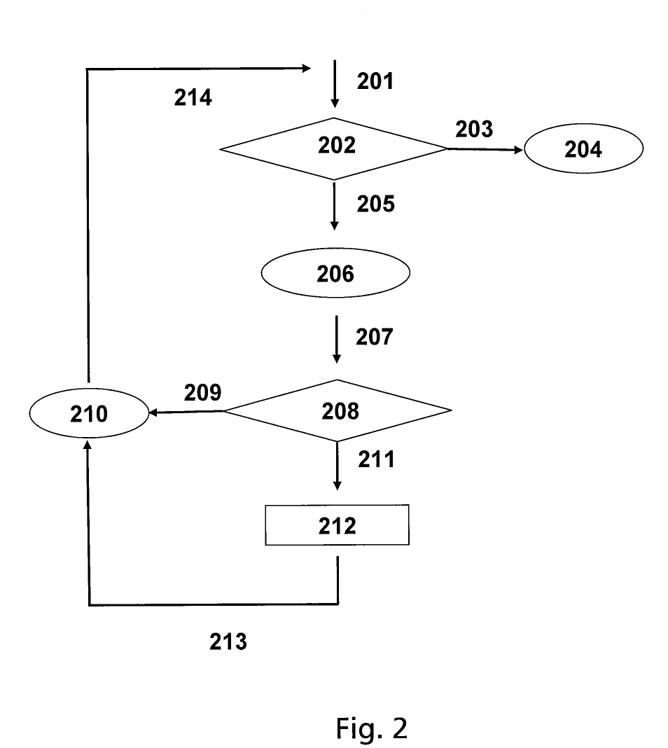

The fact that the access of external devices 101 to said community is only possible within one connectivity hop 17 from said network elements 14 is clearly illustrated by FIG. 1, in which the last hop 17 between the external devices 101 and their neighboring network element 14 is a wireless hop. Access to the community through end-devices 15 is forbidden, as the strikethrough links outside the community 16 clearly show. In this illustrated example, the external devices 101 are drawn in a diamond shape as being end-devices 15 which will thus terminate the community as leaves of the community tree 16. However, the same building process applies to network elements 14 joining the community; therefore an external device 101 is drawn with a circle shape as the other network elements 14 by way of example. The building process of the community is precisely further described in detail with the help of FIG. 2.

According to the preferred embodiment illustrated on FIG. 1, a management server 18 is provided for delivering configuration parameters covering aspects such as logging, billing, accounting, monitoring and authentication of the network elements 14. A management server 18 can be dedicated to one community starting from edge of an ISP and building an autonomous subnetwork, or designed for managing a plurality of communities corresponding to different subnetworks simultaneously. According to a preferred embodiment of the invention, one management server manages several communities, but is neither dedicated to a single community, nor acting as a centralized server for all communities, although such implementation options would also be possible according to the invention. Such an assignment of a management server 18 preferably to a plurality of community ensures a maximal flexibility for the network design.

In the case of a public Hot-Spot configuration, such a management server 18 is preferably combined with a so-called Access Controller in the back-end of the WLAN network. A local database 19 can be provided, preferably inside the management server 18 as illustrated, but also possibly in a standalone fashion outside the management server 18, in order to store identification and authentication parameters of the network elements 14 within the community, such as e.g. a correspondence table between a serial number identifying a network element 14 and its supposed location or any other geographical positioning data. An indication on the location of the network element 14 can then be asked during its installation in order to validate its authentication. This indication may be entered by the user, possibly requiring his signature or electronic signature, and/or automatically determined, possibly using a satellite-based localization system such as GPS, or any other trusted localization system. Alternatively, the management servers 18 can dispose of all required configuration information to allow for an automatic set-up of the community 16, which happens stage-by-stage each time a new child network element joins the community. Preferably, such a server 18 and a corresponding database 19 are distributed in all subnetworks. A centralized architecture with a central database for storing authentication and configuration data is also possible.

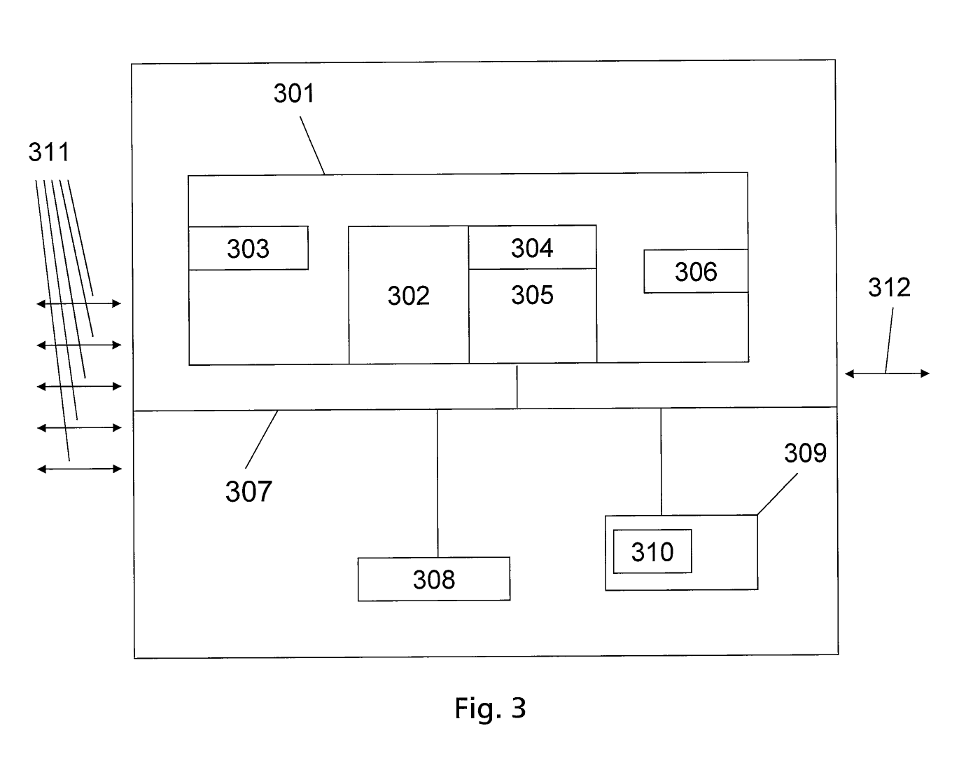

The management server 18 can be operated by an ISP directly or by a third party service provider in charge of aggregating and managing all communities of different subnetworks. The registration process of the network elements 14 to provide trustworthy identification and authentication parameters of both end-users and network elements can use the credentials provided by several different ISPs to build up a largest possible traceable community 16. On the one hand, location information is retrieved from a configuration module, described later in this document with the help of FIG. 3, which is preferably set up remotely before the network element is sent on site; on the other hand, the decentralized control based on both the trusted parent-child relationship and the location of the parent ensures the consistency of the location information of all network elements of the community while building it.

According to a preferred embodiment of the invention, the management server 18 also serves to check distances between geographical neighbors of the community in order to bring an additional control level e.g. in case network elements 14 are displaced or removed. In case of unwanted changes within the community, the management server can possibly trigger the blocking of network elements 14 for which a trusted relationship has been lost and for which inputs on identity and/or location thus need to be provided again in order to recover it.

Despite the fact that the network elements 14 are represented as homogeneous on FIG. 1, they encompass potentially any type of broadband access equipment such as a network cards, routers, switches, and bridges beside access points; the same applies to any end-device 15 which can be laptops, PDAs or smartphones. The built traceable community 16 according to the invention does not prevent from having heterogeneous network elements 14 and end-devices 15 as part of it. Furthermore, it has been chosen to start the traceable community at the border of the ISP network 12 for obvious business reasons, since there is no need to have a duplicate traceability system inside the ISP; however the traceable community 16 according to the invention could possibly also comprise network elements 14′ of the ISP network.

FIG. 2 shows a state diagram on how the traceable community 16 is built up through a parent-child process for the network elements 14. The step 201 corresponds to a connection request from an external device 101 whose type is not known yet, and can be classified either as a network element 14 or an end-device 15 terminating a branch of the community 16. Therefore, a preliminary check 202 is performed in order to determine whether the device wishing to connect is compatible with the local Internet regulation system (a.k.a. LIRS, allowing belonging to the traceable community 16) according to the invention. If LIRS compliance is not met (arrow 203), then the device is considered as a child end-device 204 and will be prevented from sharing its network connection to any user behind it. Any network connection is refused through a child acknowledged as an end-device 204. The LIRS compliance test 202 is carried out e.g. by checking whether a presence signal, broadcast by any LIRS compliant device, is received or not by the network element 14 through which the broadband connection request 201 is performed. As will be explained later, this network element receiving broadband connection requests is referred to as a parent 210, whereas the devices performing the broadband requests are referred to as its children. All the network elements 14 of the community must dispose of a LIRS software capable of performing this test in order to be classified so, as opposed to end-devices. The modules of this LIRS software are described in detail further in this document with the help of FIG. 3.

If, on the other hand, the LIRS compliance test is successful (arrow 205), the external device 101 becomes a child network element 206. The child network element 206 is able to send a broadcast signal (step 207) in order to determine whether a parent exists in the network. This step of checking the existence of a parent 208 can turn the child network element 206 directly into a parent 210 (arrow 209) if no parent is detected, in which case the child becomes also the first non-regulated intermediary element of the traceable community currently set up. If a parent is detected (arrow 211), the child is authenticated by its parent in a further step 212. If the authentication is successful, then the positioning and traceability capabilities of the parent network element which has authenticated the child network element 206 are delegated to the child (step 213), so that the child 206 can in turn be a parent 210 for further devices wishing to join the community and the community can continue to grow behind it. The delegation process preferably lies in a signal sent or an event triggered from the parent to activate the local Internet regulator (LIR, described further in detail in this document with the help of FIG. 3) from the child network element. The authenticated child 206, now potentially a parent 210, can also actively wait for new connections requests 214 and grant access to the community network until a new request comes as in step 201, hence closing the loop of the diagram. According to a preferred embodiment of the invention, the authentication process 212 of the child network element 206 can use a preliminary knowledge of a geophysical address and an IP address is dynamically assigned to the child network element 206 by its parent network element 210 only after a successful authentication.

FIG. 3 shows a system with an embedded LIRS according to a preferred embodiment of the invention, wherein the top half of the figure shows the software modules pertaining to the LIRS and the bottom half of the figure shows the hardware elements constituting the system. As will be detailed in the following paragraphs of this document, the LIRS comprises a dedicated module for managing traceability within said community (303), a dedicated module for authenticating devices joining said community (302), and a module for determining and logging geographical positioning (305). The LIRS software package 301 is installed, in all network elements 14 of the community 16 of the FIG. 1, possibly directly by the manufacturer of the network elements 14, by an ISP, or by the service provider operating the management server 18 before shipping them on-site for installation.

The LIRS software 301 comprises a so-called IRM-enabler 302—whereby IRM stands for Internet risk management—for authenticating child network elements wishing to join the community. Any authentication method is potentially supported by the LIRS, such as password, public key cryptography, LDAP, Kerberos, etc. The IRM enabler is also meant for authenticating the users of end-devices in case the child network elements are so classified, depending e.g. whether a broadcast presence signal is received or not.

The LIRS 301 further comprises a so-called LIR 303 (local Internet regulator) which is meant to establish and manage the child arborescence. Once a trust relationship is established between the child and its parent network element upon successful authentication, the network access is unblocked for the child network elements, allowing them to share their network connections. The LIR 303 is also in charge of classifying the type of external devices 101 joining the community in actively waiting for presence signals. In case the child is identified as LIRS-compliant by its parent, and thus as a non regulated Internet intermediary, positioning and traceability can be delegated, so that the configuration can happen automatically stage-wise, whereby the growth of the community results from the child extensions. In case the children are simply end-devices 15, traceability is nonetheless kept as well on the information flow between the end-devices and the parent network element.

Traceability is to be understood here as the ability to track, log or record characteristics of, block and filter any communication flow between network elements of the community, while positioning refers to the capability to precisely define the geographical location of a network element. Those two aspects are combined in thanks to the introduction of a so-called “local Internet address” LIA 304 according to the invention. The LIA is, according to a preferred embodiment of the invention, an IP address with an extension for indicating the geographical positioning. The geographical positioning can be a geophysical address, based on administrative, regional, postal structures, or a geocode or geospatial coordinate, such as latitude and longitude. The geographical indication simply needs to be converted into a computer readable format.

The LIA manager 305 is in charge of determining the geographical positioning of the new child network elements as well as the own geographical positioning of the parent. It also creates and delivers the LIAs 304 of the child network elements. As explained previously with the help of FIG. 2, two cases are possible for the LIA configuration of a network element: either through the bootstrapping process, in which the LIA is created from scratch, or the LIA is received from a parent network element. As soon as a child is authenticated and can act itself as a parent, it can then create and deliver an LIA for each of its identified children.

Going back now to FIG. 3, according to a preferred embodiment of the invention the LIA manager 305 acts as an enhanced DHCP (dynamic host control protocol) for delivering IP addresses to child network elements. It preferably requires a preliminary knowledge of the geographical positioning of the child network elements requesting a connection before any IP address can be attributed to the child. Preferably the geographical information provided by the child is then verified during the authentication process, with the credentials and identity parameters altogether. In case the child network element is identified as an end-device, its geographical positioning will be determined directly by the geographical positioning of its parent. In this case, the local Internet address 304 of the end-devices 15 is preferably based on the local Internet address 304 of the parent network element 14 of this said end-device 15, with just a different IP address assignment for network routing purposes. The accuracy of the yielded positioning of the end-devices is satisfactory for most Wi-Fi standards such as 802.11a and 802.11g for which a bandwidth over 10 Mbps can be reached only within a range of about 10 meters around the access points.

The bootstrap 306 is used for the first connection of a LIRS compliant network element to a source of bandwidth. It activates the broadcast of a presence signal to check the existence of a parent network element and follows then the steps of FIG. 2 as of step 207 since the device is already acknowledged as a compliant LIRS compliant child network element 206. Therefore, possibly the bootstrap 306 can lead to the creation of an own LIA 304 for the configured network element.

The hardware requirements to implement a LIRS are quite minor, so that a LIRS module 301 can be implemented on any type of broadband access equipment. At the bottom of FIG. 1, a CPU 308 and a memory unit 309 are illustrated, as well as a communication bus 307 for allowing data transmission between all internal modules. According to a preferred embodiment of the invention, part of the memory unit is dedicated to store configuration data and can hence be referred to as configuration module 310. It can be appreciated that the configuration module can be designed as standalone memory unit as well. Preferably the information stored in the memory unit is remotely accessible through a network management protocol, e.g. SNMP.

Preferably the configuration module 310 contains all authentication and configuration data apart from the LIAs 304. Those configuration data are usually obtained from a management server and can be, according to the business model used to implement the traceable community, directly provided by end-users wishing to adhere to such a community in submitting a form containing all the required information, or the necessary configuration parameters and credentials can be obtained through ISPs databases or resellers which have at their disposal identification and authentication information about their customer base that is considered as trustworthy. The way with which the credentials dealing with the network element and its owner are obtained is in any case oblivious to the posterior parent-child community set-up process.

According to a preferred embodiment of the invention, the configuration module 310 also helps check the geographical neighborhood in which a network element 14 is placed, and brings an additional control layer on top of the location verification by both the child and parent within the trusted child parent relationship. A trusted neighborhood relationship is established in creating a table listing all the network elements in the vicinity of a given network element, and checking the consistency of this vicinity information e.g. thanks to the management server 18. The presence of neighbor network elements 14 can be detected by a presence signal and automatically entered in the configuration module, or periodically manually entered by the end-user of a network element 14. The correspondence tables, e.g. in the database 19 of the management server 18, between serial numbers of the network elements 14 and their geographical positioning, can then be compared to the neighborhood tables provided by the configuration modules. The aggregation of neighborhood information consists in a distinct and independent way to check the consistency of the geographical positioning of the network elements, and allows to reliably follow the positioning changes of network elements 14 within the community, whenever such changes happen.

The arrows 311 and 312 of FIG. 3 highlights the fact there are, according to the illustrated preferred embodiment of the invention, only one parent for each child (arrow 312 for the child to parent connection) while there are possibly many children for one parent within a network (arrows 311 for the parent to child connections). Other network topologies are possible but would require a disambiguation for the IP address assignment through different parents, e.g. in having virtual interfaces for each parent.

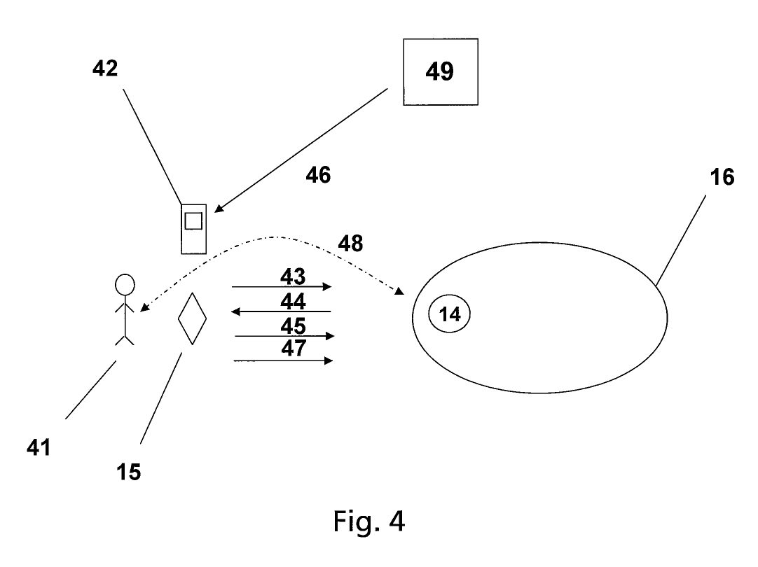

FIG. 4 shows a preferred embodiment used for authenticating an end-user 41 to the community 16 so that the traceability is provided not only to the end-device 15 of the user, but to the physical person using it. As soon as end-devices 15 are detected by a parent network elements 210 (see FIG. 2), it is the end-users 41 of said end-devices 15 that are identified and authenticated, and not or not only the end-devices 15. This feature of keeping a direct logical link, illustrated by arrow 48, between the established community of network elements 16 and the Internet users is very important for fighting cybercrime in knowing in real-time who is accessing the Internet and from where, with an acceptable accuracy as required by the legal authorities. As soon as end-devices 15 are identified, the traceability capability of the invention focuses therefore on determining who are behind those end-devices rather than the end-devices themselves, so that authentication is preferably performed based on user credentials and not on identification parameters such as serial numbers or MAC addresses etc. of the end-devices 15 anymore. According to this preferred embodiment, the end-devices 15 are thus used for positioning the end-users 41, but traceability is performed directly until the end-users 41 without requiring any information on the end-device 15 itself.

In FIG. 4, the end-user 41 disposes of any type of broadband access equipment, such as a laptop 15, and also another end-device, such as a mobile phone 42. The embodiment involving a mobile phone should however not be interpreted in a limitative way; e.g. a fixed phone or another communication end-device could also be used for the same purposes. In order for no mistake to arise between the other end-device 42 used for the authentication and an end-device 15 of the community, according to a preferred embodiment, the other end-device precisely does not belong to the community, as it is the case with a mobile phone 42. When a connection request is sent by the end-device (step 43), the network element 14, which has received the request, and had turned into a parent state 210 (see FIG. 2) prior to this request, sends e.g. an http request (step 44) of a web page to fill in with required fields allowing to identify and authenticate the user, such as a mobile phone number, and possibly other fields (name, address etc.). The end-device returns to the web page completed with the required fields (step 45). Once this information is received, it is forwarded to an SMS server 49 which transmits a password through an SMS (step 46) to the mobile phone 42. The password is then submitted (step 47) for authenticating the end-user which is granted the access to the network.

The man skilled in the art will understand that any user authentication mechanism is potentially supported by the invention, and does not necessarily involve additional devices in the authentication process. Furthermore, registration of end-users wishing to join the community can be made through web forms indicating a name and physical location to which hardware will be sent, or any trustworthy mechanism possibly in collaboration with telecom operators or ISPs. Other end-devices, such MP3 playing devices, could also be used, whereby the trusted relationships could consist e.g. in their serial number which should be submitted e.g. through a web form. It can also be foreseen to use credit card numbers, as well as any fidelity program identification numbers which can be considered as trustworthy to identify an end-user. Choice could even be given to an end-user as to which credential he or she wishes to use to be identified and authenticated.

Given the minimal device capabilities requirements for implementing the LIRS system providing a universal solution usable with any type of network device, the LIRS software modules 301 could be downloaded either from a web site, or directly from the management server 18 while setting the device up.

The disclosed positioning and traceability solution provides an easy operable solution, substituting to GPS for the localization purposes, and substituting to ISP identification and authentication mechanisms for non managed and/or hitherto non manageable network elements. It complies with possibly any desirable identification and authentication processes and technologies. As a result, Internet risk management is enabled in refusing Internet Access for non traceable users. The geographical positioning traceability capabilities provided further comply with the desired requirements of local authorities with an accuracy of an order of magnitude of tens of meters at most.

### REFERENCE LIST

10 Web
11 Regulated Internet intermediaries
12 ISP Network
13 Non regulated Internet intermediaries
14 Non regulated network element (NE)
14′ Network elements of the ISP
14″ Boarder ISP network element
15 End-device
16 Traceable community
17 Connectivity hop
18 Management server
19 Database
101 Network device external to the community
201 Network element connection request
202 LIRS compliance check
203 Compliance check not successful
204 Child identified and an end-device not allowed to share bandwidth
205 Compliance check successful
206 Child identified as a network element
207 Step of sending a broadcast signal to parent
208 Checking existence of parent NE
209 No parent detected
210 Parent NE state
211 Parent detected
212 Child authentication step
213 Step of delegating positioning and traceability to child
214 Active waiting for new connection requests
301 LIRS module
302 IRM enabler
303 LIR module
304 LIA
305 LIA manager
306 Bootstrap
307 Communication bus
308 CPU
309 Memory unit
310 Configuration module
311 Parent to child link
312 Child to parent link
41 End-user
42 Other End-device used for the authentication (e.g. mobile phone)
43 Step of sending a connection request through the end-device
44 Step of requesting a web page to fill in
45 Step of returning the web page with the completed required fields
46 Step of transmitting an SMS with a password
47 Step of submitting the password for authentication
48 Direct link to the end-user
49 SMS server

1. A method for enforcing Internet users' geographical positioning traceability, comprising:
building a community of several network elements with known geographical location;
controlling and authorizing network access to said community; allowing access of external devices to said community only within one connectivity hop from said network elements in said community.

2. The method of claim 1, comprising:
identifying a boundary of said community, said boundary consisting of a set of network elements in said community, said networks being referred to as end-devices; setting-up said community through a parent-child configuration process during which access is granted by network elements in said community to child elements.

3. The method of claim 1, wherein bandwidth sharing and Internet access through said network elements of said community are refused to any child network element until said child network element is successfully authenticated.

4. The method of claim 1, comprising an authentication process of child network elements using a preliminary knowledge of a geophysical address of said child network element, wherein an IP address can be assigned to said child network element only after successful authentication.

5. The method of claim 1, wherein location awareness of said network elements is based on a local Internet address consisting of an IP address with an extension indicating a geographical positioning.

6. The method of claim 5, wherein said geographical positioning is indicated with a geophysical address or geospatial coordinates.

7. The method of claim 5, wherein said local Internet address of said end-devices is based on the local Internet address of the parent network element of said end-device.

8. The method of claim 1, wherein a management server provides configuration parameters to said network elements and allows for an automatic set-up of said community.

9. The method of claim 1, wherein the configuration process of said community uses a database storing correspondence tables between serial numbers of said network elements and geographical positioning data.

10. The method of claim 9, wherein further a trusted neighborhood relationship is established.

11. The method of claim 1, wherein parent network elements identify and authenticate end-users of said end-devices.

12. The method of claim 11, wherein end-users of said end-devices are identified and authenticated with the help of another end-device.

13. A network access device for enforcing Internet users' geographical positioning traceability, comprising a software module for regulating network access, authenticating and localizing devices performing broadband connection requests to said network access device, characterized in that said software module is arranged for classifying said devices performing said broadband requests into network elements and end-devices, wherein only network elements are allowed to share their network connection, and in that said software module is arranged for authenticating directly end-users of said end-devices.

14. The network access device of claim 13, said module comprising a dedicated module for managing traceability within a community of said network elements, a dedicated module for authenticating devices joining said community, and a module for determining and logging geographical positioning.

15. The network access device of claim 13, comprising a memory unit for storing geographical and/or identification information, whereby said information is remotely accessible through a network management protocol.

16. The network access device of claim 13, wherein the software modules can be downloaded from a management server or a web site.

17. A system for enforcing Internet users' geographical positioning traceability, comprising network access devices according to claim 13 and a central database for authenticating said network access devices and store user's credentials.

18. A management server for enforcing Internet users' geographical positioning traceability, said management server providing configuration parameters to network elements and allowing for an automatic set-up of a community of network elements aware of their geographical location.
